(19) United States
(12) Patent Application Publication
(10) Pub. No.: US 2025/0196684 A1
(43) Pub. Date: Jun. 19, 2025

(54) INFORMATION PROCESSING APPARATUS, POWER FEEDING APPARATUS, POWER FEEDING METHOD AND A NON-TRANSITORY COMPUTER READABLE MEDIUM

(71) Applicant: TOYOTA JIDOSHA KABUSHIKI KAISHA, Toyota-shi (JP)

(72) Inventors: Kento IWAHORI, Nagoya-shi (JP); Yasuhiro Saito, Toyoake-shi (JP); Daiki Yokoyama, Miyoshi-shi (JP)

(73) Assignee: TOYOTA JIDOSHA KABUSHIKI KAISHA, Toyota-shi (JP)

(21) Appl. No.: 18/946,318

(22) Filed: Nov. 13, 2024

(30) Foreign Application Priority Data
Dec. 19, 2023 (JP) 2023-214216

(51) Int. Cl. B60L 53/36; B60L 53/16; B60L 53/37

(52) U.S. Cl. CPC B60L 53/36; B60L 53/16; B60L 53/37; B60L 2260/32

(57) ABSTRACT

An information processing apparatus capable of efficiently charging vehicles is provided. An information processing apparatus including: an acquisition unit configured to acquire first information on a specification of power feeding of a first vehicle; a power feeding apparatus specification unit configured to specify a power feeding apparatus that feeds electric power to the first vehicle based on the acquired information on the specification; and an information creation unit configured to create second information requested for the first vehicle, a second vehicle which power is fed to by the power feeding apparatus and is closer to the power feeding apparatus than the first vehicle is, or the power feeding apparatus is provided. The second information may be information for switching an order of the first vehicle and the second vehicle.

### CROSS REFERENCE TO RELATED APPLICATIONS

This application is based upon and claims the benefit of priority from Japanese patent application No. 2023-214216, filed on Dec. 19, 2023, the disclosure of which is incorporated herein in its entirety by reference.

### BACKGROUND

The present disclosure relates to an information processing apparatus, a power feeding apparatus, a power feeding method, and a program.

Japanese Unexamined Patent Application Publication No. 2022-56840 discloses a charging system for charging an electric vehicle. In Japanese Unexamined Patent Application Publication No. 2022-56840, a power feeding robot feeds electric power to an electric vehicle.

### SUMMARY

In vehicle manufacturing factories, it is required to efficiently charge vehicles. Therefore, an object of the present disclosure is to provide an information processing apparatus, a power feeding apparatus, a power feeding method, and a program capable of efficiently charging vehicles.

An information processing apparatus according to the present disclosure includes: an acquisition unit configured to acquire first information on a specification of power feeding of a first vehicle; a power feeding apparatus specification unit configured to specify a power feeding apparatus that feeds electric power to the first vehicle based on the acquired information on the specification; and an information creation unit configured to create second information requested for the first vehicle, a second vehicle which power is fed to by the power feeding apparatus and is closer to the power feeding apparatus than the first vehicle is, or the power feeding apparatus.

By the above-described configuration, an information processing apparatus capable of efficiently charging vehicles is provided.

The information processing apparatus according to the present disclosure includes a transmitting unit configured to transmit the second information to the first vehicle, the first vehicle is controlled based on the second information, and the second information may be at least one of: a route along which the first vehicle moves to the specified power feeding apparatus; or a control instruction value of the first vehicle for causing the first vehicle to move to the power feeding apparatus; or a route of the first vehicle for switching an order of the first vehicle and the second vehicle; or a control instruction value of the first vehicle for switching the order of the first vehicle and the second vehicle.

By the above-described configuration, the first vehicle is controlled to move toward the power feeding apparatus. Further, taking into consideration charging efficiency, it is possible to charge the first vehicle prior to charging the second vehicle.

The information processing apparatus according to the present disclosure is mounted on the first vehicle, the first vehicle is controlled based on the second information, and the second information may be at least one of: a route along which the first vehicle moves to the specified power feeding apparatus; or a control instruction value of the first vehicle for causing the first vehicle to move to the power feeding apparatus; or a route of the first vehicle for switching an order of the first vehicle and the second vehicle; or a control instruction value of the first vehicle for switching the order of the first vehicle and the second vehicle.

By the above-described configuration, the first vehicle is controlled to move toward the power feeding apparatus. Further, taking into consideration charging efficiency, it is possible to charge the first vehicle prior to charging the second vehicle.

The information processing apparatus according to the present disclosure includes a transmitting unit configured to transmit the second information to the second vehicle, the second vehicle is controlled based on the second information, and the second information is at least one of: a route of the second vehicle for switching an order of the first vehicle and the second vehicle; or a control instruction value of the second vehicle for switching the order of the first vehicle and the second vehicle; or information on the second vehicle deviating from the power feeding apparatus.

By the above-described configuration, taking into consideration charging efficiency, it is possible to charge the first vehicle prior to charging the second vehicle.

The information processing apparatus according to the present disclosure may be mounted on the first vehicle.

By the above-described configuration, taking into consideration charging efficiency, it is possible to charge the first vehicle prior to charging the second vehicle.

In the information processing apparatus according to the present disclosure, the order of the first vehicle and the second vehicle may not be switched when the second vehicle is behind the first vehicle by more than a predetermined number of vehicles.

By the above-described configuration, the order of manufacturing the second vehicle is not delayed too much.

In the information processing apparatus according to the present disclosure, the order of the first vehicle and the second vehicle may not be switched when the second vehicle is a predetermined vehicle.

By the above-described configuration, when the second vehicle is a predetermined vehicle, it can be preferentially manufactured.

In the information processing apparatus according to the present disclosure, the order of the first vehicle and the second vehicle may be switched in such a way that vehicles having the same power feed connector are sequential.

By the above-described configuration, it is possible to continuously use one power feed connector so as to be able to efficiently feed electric power.

In the information processing apparatus according to the present disclosure, the power feeding apparatus specification unit may specify the power feeding apparatus in such a way that vehicles whose specifications of power feeding are the same are sequential.

By the above-described configuration, it is possible to efficiently feed electric power.

In the information processing apparatus according to the present disclosure, the first information may be acquired by referring to production management information.

The above-described configuration is one example of a method for acquiring first information.

In the information processing apparatus according to the present disclosure, a method in which a charging speed is high may be preferentially used when the first vehicle has a plurality of power feeding methods.

By the above-described configuration, it is possible to efficiently feed electric power.

In an information processing apparatus according to the present disclosure, the second information may be information on a specification of power feeding of the first vehicle, and the information processing apparatus may include a transmitting unit configured to transmit the second information to the power feeding apparatus.

By the above-described configuration, the power feeding apparatus is able to acquire information on a specification of a vehicle which power is fed to.

A power feeding apparatus according to the present disclosure includes: an acquisition unit configured to acquire information on a specification of power feeding of a vehicle; and a power feeding control unit configured to prepare for feeding power based on the acquired information on the specification of power feeding.

By the above-described configuration, the power feeding apparatus is able to prepare for feeding power efficiently.

In the power feeding apparatus according to the present disclosure, the preparation for the power feeding may include: determining whether or not to remove the connector to be used to feed electric power in accordance with a specification of power feeding of the vehicle; maintaining the connector when it is determined that there is no need to remove the connector; and connecting, when it is determined that it is necessary to remove the connector, a connector in accordance with the specification of power feeding of the vehicle.

The above-described configuration is one example of a method for efficiently performing contact power feeding.

In a power feeding apparatus according to the present disclosure, when vehicles conforming to the first connector are sequential and then vehicles conforming to the second connector are sequential in the power feeding apparatus, the first connector may be replaced with the second connector after the sequence of the vehicles conforming to the first connector is completed but before the vehicles conforming to the second connector come to the power feeding apparatus.

By the above-described configuration, the power feeding apparatus is able to efficiently perform contact power feeding.

In the power feeding apparatus according to the present disclosure, the preparation for the power feeding may include: determining, in accordance with a specification of power feeding of the vehicle, whether or not to change a power feeding voltage of a power feeding unit; maintaining the voltage when it is determined that there is no need to change the power feeding voltage; and changing, when it is determined that it is necessary to change the power feeding voltage, the power feeding voltage to one in accordance with the specification of the power feeding of the vehicle.

The above-described configuration is one example of the method for efficiently performing non-contact power feeding.

In the power feeding apparatus according to the present disclosure, when vehicles conforming to the first power feeding voltage are sequential and then vehicles conforming to the second power feeding voltage are sequential in the power feeding apparatus, the power feeding voltage may be changed from the first power feeding voltage to the second power feeding voltage after the sequence of the vehicles conforming to the first power feeding voltage is completed but before the vehicles conforming to the second power feeding voltage come to the power feeding apparatus.

By the above-described configuration, the power feeding apparatus is able to efficiently perform non-contact power feeding.

A power feeding method according to the present disclosure is a power feeding method including: acquiring first information on a specification of power feeding of a first vehicle; specifying a power feeding apparatus that feeds electric power to the first vehicle based on the acquired information on the specification; and creating second information requested for the first vehicle, a second vehicle which power is fed to by the power feeding apparatus and is closer to the power feeding apparatus than the first vehicle is, or the power feeding apparatus.

By the above-described configuration, a power feeding method for efficiently charging vehicles is provided.

A program according to the present disclosure is a program for causing an information processing apparatus to execute: acquiring first information on a specification of power feeding of a first vehicle; specifying a power feeding apparatus that feeds electric power to the first vehicle based on the acquired information on the specification; and creating second information requested for the first vehicle, a second vehicle which power is fed to by the power feeding apparatus and is closer to the power feeding apparatus than the first vehicle is, or the power feeding apparatus.

By the above-described configuration, a program for causing an information processing apparatus to efficiently charge vehicles is provided.

According to the present disclosure, it is possible to provide an information processing apparatus, a power feeding apparatus, a power feeding method, and a program capable of efficiently charging vehicles.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram showing a whole configuration of a power feeding system according to an embodiment;

FIG. 2 is a block diagram showing a control system of a power feeding system according to the embodiment;

FIG. 3 is a first flowchart of a power feeding method according to the embodiment;

FIG. 4 is a second flowchart of the power feeding method according to the embodiment;

FIG. 5 is a diagram showing a timing for changing connectors of a power feeding apparatus according to the embodiment;

FIG. 6 is a diagram showing an example for switching an order of power feeding vehicles having different connectors according to the embodiment;

FIG. 7 is a diagram showing an example of selecting a power feeding apparatus in such a way that power feeding vehicles have the same type of power feeding according to the embodiment;

FIG. 8 is a diagram showing an example for switching an order of power feeding vehicles whose power feeding types are different from each other according to the embodiment;

FIG. 9 is a diagram showing an example of selecting a power feeding apparatus in such a way that power feeding vehicles have the same type of power feeding according to the embodiment;

FIG. 10 is a diagram for explaining control of the traveling of a vehicle;

FIG. 11 is a control block diagram for explaining Traveling Control Example 1;

FIG. 12 shows a flowchart for explaining Traveling Control Example 1;

FIG. 13 is a control block diagram for explaining Traveling Control Example 2; and

FIG. 14 shows a flowchart for explaining Traveling Control Example 2.

### DESCRIPTION OF EMBODIMENTS

### Embodiments

Embodiments according to the present disclosure will be described hereinafter with reference to the drawings. However, the invention specified in the claims is not limited to the below-shown embodiments. Further, all the components/structures described in the embodiments are not necessarily indispensable as means for solving the problem. For clarifying the explanation, the following description and drawings are partially omitted and simplified as appropriate. The same reference numerals (or symbols) are assigned to the same elements throughout the drawings and redundant descriptions thereof are omitted as appropriate.

(Description of Power Feeding System according to Embodiments)

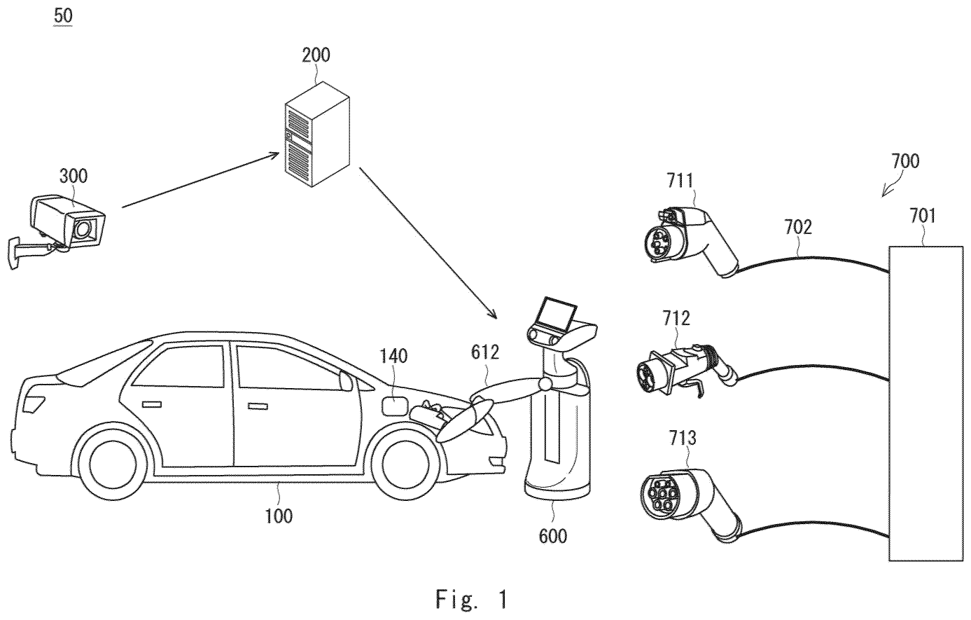

With reference to FIG. 1, a configuration of a power feeding system 50 (this system may also be referred to as a system 50) according to this embodiment will be described. For example, the power feeding system 50 is used in a vehicle manufacturing factory. When a vehicle is manufactured, the power feeding system 50 feeds electric power to a vehicle 100.

As shown in FIG. 1, the power feeding system 50 feeds (i.e., supplies) electric power to the vehicle 100. Further, the power feeding system 50 includes a server 200, an external sensor 300, a power feeding robot 600, and a power feeding apparatus 700.

The vehicle 100 includes a power feeding port 140. Alternatively, the vehicle 100 may include a coil for receiving electric power in place of the power feeding port 140. The vehicle 100 is an electric vehicle such as a battery-type vehicle or a plug-in hybrid-type vehicle. The shape and the size of the power feeding port 140 vary depending on a destination to which the vehicle 100 is shipped. For example, the type of a power feeding port 140 of a vehicle 100 for Japan, that of a vehicle 100 for North America, that of a vehicle 100 for Europe, and that of a vehicle 100 for China are different from one another. That is, vehicles 100 shipped to a plurality of destinations are produced in a factory. The vehicle 100 may be an automatic driving car that moves within a vehicle manufacturing factory by automatic control or may be a non-automatic driving car (this may also be referred to as a normal vehicle) driven by a driver.

The entity which receives electric power is not limited to the vehicle 100, but may be a mobile object other than the vehicle. In this embodiment, the mobile object is a vehicle 100, and more specifically, is a battery electric vehicle (BEV: Battery Electric Vehicle). Note that the mobile object is not limited to electric vehicles, and may be, for example, an electric motorcycle, an electric bicycle, an electric kickboard, a hybrid vehicle, or a fuel-cell vehicle. Further, the mobile object may be a vehicle including wheels or endless tracks, and may be, for example, a passenger car, a truck, a bus, a two-wheeled vehicle, a four-wheeled vehicle, a tank, a construction vehicle, or other vehicles. Further, the mobile object is not limited to the vehicle 100, and may be an electric VTOL (vertical takeoff and landing) vehicle (so-called a flying car).

The power feeding apparatus 700 feeds electric power to the vehicle 100. The vehicle 100 includes a power feeding port 140 with a specification according to its destination or a power receiving coil for non-contact power feeding. The power feeding apparatus 700 includes connectors 711-713 whose types vary depending on the specification of the power feeding port 140. The connectors 711-713 have shapes which differ in accordance with the different shapes of the power feeding ports 140. Therefore, the connectors 711-713 have different shapes, sizes and so on. The number of connectors is not limited to three, and may be any number as long as it is two or larger.

For example, a connector 711, which is a Japan-standard CHAdeMO connector, is used for vehicles 100 for Japan, and a connector 712, which is a North American standard-type 1EV connector, is used for vehicles 100 for North America. A connector 713, which is a Europe standard IEC62196-2 Type2 EV connector, is used for vehicles 100 for Europe. That is, the connectors 711-713 have shapes that match the respective power feeding ports 140 connected thereto. Further, the connectors 711-713 may not necessarily conform to the above standards and may instead conform to other standards, such as a Tesla Supercharger EV connector or a Chinese GB/TEV charging connector. As a matter of course, some of the connectors may have the same shape. That is, two or more connectors for one destination may be provided in the power feeding device 700.

Further, the power feeding apparatus 700 may be provided with a power feeding coil for non-contact power feeding. The power feeding coil for non-contact power feeding is disposed at a position corresponding to the position of the power receiving coil of the vehicle, usually such as under or in contact with the ground.

A main body 701 generates a power feeding voltage for feeding electric power to the vehicle 100. The power feeding voltage that is generated in the main body 701 is supplied to the connectors 711-713 via the codes 702. Note that the plurality of connectors 711-713 correspond to the respective types of the power feeding ports 140. Alternatively, the power feeding voltage generated in the main body 701 is supplied to the power feeding coil for non-contact power feeding. The power feeding device 700 supplies a power feeding voltage and a power feeding current conforming to the standard of the vehicle type.

The power feeding apparatus 700 includes a power feeding unit 720, a determination unit 730, and a power feeding control unit 740. The power feeding unit 720 includes connectors 711-713, a power feeding coil, or the like. The determination unit 730 determines whether or not to change a connector depending on the vehicle type. The power feeding control unit 740 supplies a voltage corresponding to the connector to the power feeding unit 720. Further, the power feeding control unit controls power feeding to the connector selected by the determination unit 730 or to the power feeding coil.

The power feeding robot 600 connects the connectors 711-713 to the power feeding port 140. For example, the power feeding robot 600 includes an arm mechanism 612 for connecting the connectors 711-713 to the power feeding port 140. The arm mechanism 612 includes a plurality of joint motors and an end effector for holding the connectors 711-713. The arm mechanism 612 selects a connector 711 suitable for the power feeding part 140 from among a plurality of connectors 711-713 and inserts the selected connector into the power feeding port 140. In this way, the power feeding apparatus 700 can supply a power feeding voltage to the power feeding port 140. Therefore, the power feeding apparatus 700 can charge a battery of the vehicle 100.

An external sensor 300 is any of various sensors, such as an infrastructure camera or LiDAR, installed in a facility such as a factory. Needless to say, two or more external sensors 300 may be installed, and two or more types of sensors may be used in combination. The external sensor 300 is a camera (e.g., a still camera or a video camera) for photographing a vehicle 100 which is moving or at a standstill. The external sensor 300 may be LiDAR. The external sensor 300 transmits its detection result to the server 200. The detection result transmitted from the external sensor 300 may be a photographed image (e.g., a still image or a moving image) or information extracted from such an image. For example, when the external sensor 300 has an image processing function, the external sensor 300 transmits information extracted by performing image processing to the server 200.

The server 200 is an information processing apparatus including a memory and a processor, and functions as a power feeding control apparatus that controls a power feeding system. For example, the server 200 receives a detection result obtained by the external sensor 300. The server 200 performs power feeding control according to the detection result or the like.

The server 200 acquires type information on the type of the power feeding port from the external sensor 300 or the vehicle 100. Then, the server 200 creates a control value for feeding electric power to the vehicle 100 according to the acquired type information. The type information is information for specifying, for example, a connector or a non-contact power receiving unit corresponding to the power feeding port from among a plurality of connectors or non-contact power feeding units.

The following description will be made based on an assumption that the specific connector specified by the type information is the connector 711. The server 200 creates a control value for performing power feeding using the connector 711 in accordance with the type information, and transmits the created control value to the power feeding robot 600. Then, the power feeding robot 600 opens a lid of the power feeding port 140. The power feeding robot 600 selects the connector 711 in accordance with the type information and grasps the selected connector 711. The power feeding robot 600 inserts the connector 711 into the power feeding port 140. Accordingly, the connector 711 that conforms to the particular standard of each of the power feeding ports 140 can be connected to the power feeding robot 600.

Further, in the case of non-contact power feeding, the position of the power receiving coil of the vehicle 100 is aligned with the position of the power feeding coil of the power feeding apparatus 700. Electricity generated by an electromotive force induced by the power feeding coil is transmitted (i.e., supplied) to the power receiving coil, and then fed (i.e., supplied) to the vehicle 100.

### (Control Block)

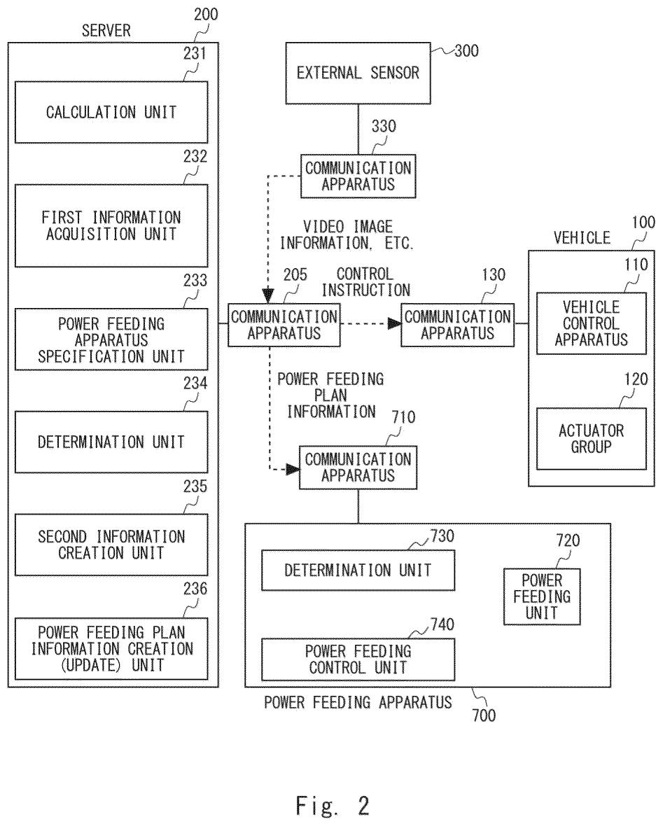

With reference to FIG. 2, control of the power feeding system will be described in detail. FIG. 2 is a block diagram showing a control system of the power feeding system 50.

The server 200 includes a calculation unit 231, a first information acquisition unit 232, a power feeding apparatus specification unit 233, a determination unit 234, a second information creation unit 235, and a power feeding plan information creation (update) unit 236. Further, the server 200 includes a communication apparatus 205 that transmits and receives data to and from the first vehicle 100, the second vehicle 100, the external sensor 300, the power feeding apparatus 700, and the like. Note that the server 200 is not limited to a single physical apparatus, and may be one that is provided in a distributed manner. For example, its database may be a storage device or a cloud server provided separately from its processor.

The external sensor 300 includes a communication apparatus 330 that transmits and receives data to and from the server 200. The communication apparatus 330 transmits an (e.g., a still image or a moving image) photographed by the external sensor 300 to the server 200. The communication apparatus 330 may transmit not only the photographed image but also information obtained from the photographed image to the server 200. That is, the communication apparatus 330 transmits a detection result detected by the external sensor 300. Note that the communication apparatus 330 may be incorporated into the external sensor 300 or may be provided as a separate apparatus. Further, one communication apparatus 330 may be used by a plurality of external sensors 300. That is, in the case where a plurality of external sensors 300 are installed, one communication apparatus 330 may transmit their data to the server 200.

The calculation unit 231 calculates position information indicating the position and orientation of the vehicle based on the photographed image. For example, the calculation unit 231 can calculate the coordinates of the vehicle in the XYZ global coordinate system and the azimuth thereof in the factory map. At least a part of the processing performed by the calculation unit 231 may be performed in the external sensor 300. For example, the external sensor 300 may include a processor that performs image processing. In this case, position information indicating the position or the like of the vehicle 100 is transmitted from the communication apparatus 330 to the communication apparatus 205.

The position and orientation of the vehicle 100 may be estimated by using a photographed image acquired by the external sensor 300 provided at a place different from that of the vehicle 100. Regarding the position of the vehicle 100, it is possible to acquire it, for example, by calculating the coordinates of the positioning point of the mobile object in the image coordinate system by using the external shape of the vehicle 100 detected from the photographed image, and converting the calculated coordinates into coordinates in the global coordinate system. Regarding the orientation of the vehicle 100, it is possible to estimate it, for example, based on the orientation of the moving vector of the mobile object calculated from changes in the positions of the feature points of the mobile object between frames of the photographed images by using an optical flow method. The orientation of the vehicle 100 may be calculated by using, for example, output results of a speed sensor, a yaw rate sensor, or the like installed in the vehicle 100.

It is possible to detect the external shape of the vehicle 100 included (i.e., shown) in the photographed image by, for example, inputting the photographed image into a detection model using artificial intelligence. Examples of detection models include a trained machine-learning model that has been trained to perform either semantic segmentation or instance segmentation.

As this machine-learning model, for example, a convolutional neural network (hereinafter also referred to as a CNN) trained through supervised learning using a learning data set can be used. The learning data set includes, for example, a plurality of training images each including a mobile object and correct labels each indicating whether a respective area in the training image is an area indicating a mobile object or an area that does not indicate a mobile object. When the CNN is trained, it is preferred that parameters of the CNN are updated by backpropagation (error back-propagation method) so that errors between output results by the detection model and correct labels are reduced.

The first information acquisition unit 232 acquires first information on the specification of the power feeding of the first vehicle 100. The first information is, for example, information correlated to a specification of power feeding, such as destination information or vehicle type information. The first information acquisition unit 232 may acquire type information from the image taken by the external sensor 300. The first information acquisition unit 232 may acquire type information from the identification information of the first vehicle 100 that stops at a place where the power feeding is prepared. For example, the first information acquisition unit 232 accesses the database for factory production management to acquire production management information. Since the destination is registered for each vehicle in the production management information, the first information acquisition unit 232 can read the destination from the identification information or the like of the first vehicle 100.

Further, in the case where power feeding information related to a target SOC (State of Charge) or the like is set when the vehicle is shipped, the first information acquisition unit 232 reads the power feeding information from the database. When, for example, the target SOC at the time of shipment is set according to the destination, electric power is fed (i.e., supplied) to the vehicle so that the system 50 meets the target SOC. Only the lower limit value may be set, or a range of which the upper and lower limit values are set may be used. Further, the power feeding apparatus 700 may not only supply electric power so as to attain the target SOC, but may also consume electric power when the actual SOC of the vehicle is higher than the target SOC thereof. When the SOC is too high in the transportation process to the destination, the battery may deteriorate, whereas when the SOC is too low, the battery may run out of electric power. Therefore, the vehicle may be shipped after the SOC is adjusted into a predetermined range.

The specification of contact power feeding in the power feeding apparatus 700 can be 1) rapid charge or normal charge, 2) standard in each country, and 3) variation of a location where a power feeding port is installed. When the power feeding apparatus 700 performs rapid charge only, the specification is limited to one pattern of rapid charge. Further, when, for example, a factory handles only products for Japan, the standard in each country is limited to one pattern. The location where the power feeding port is installed may be one of the right or left side of the vehicle. When, for example, the location where the power feeding port is installed is only the right or left side of the vehicle, the location where the power feeding port is installed is limited to one pattern. There may be other variations regarding the specification of the power feeding port.

The specification of non-contact power feeding in the power feeding apparatus 700 may be 1) non-contact charging while being stopped or non-contact charging during driving, 2) rapid charge or normal charge, and 3) variation of the standard in each country. Their variations are also limited depending on the type of a vehicle manufactured at a factory. There may be other variations regarding the specification of the non-contact power feeding.

The power feeding apparatus specification unit 233 specifies the power feeding apparatus that feeds electric power to the first vehicle 100 based on the acquired information on the specification. In the power feeding apparatus 700, a plurality of vehicles which electric power should be fed to wait in line. In the power feeding apparatus 700, for example, a second vehicle 100, which electric power is to be fed to by a power feeding apparatus and is closer to the power feeding apparatus 700 than the first vehicle 100 is, is waiting to be powered.

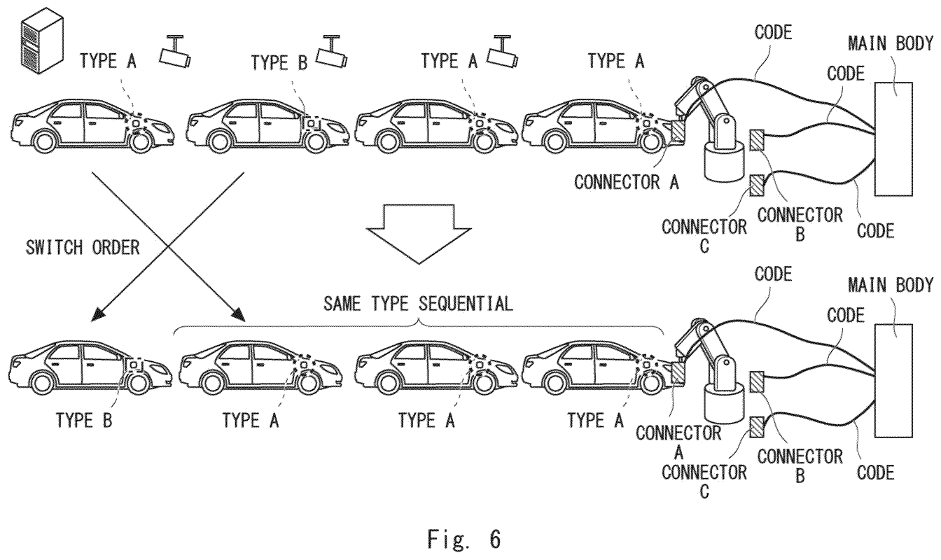

By switching the order of feeding electric power to the first vehicle 100 and feeding electric power to the second vehicle 100 in view of the relationship between the power feeding apparatus 700 and the second vehicle, it is possible to improve efficiency of power feeding. For example, as shown in FIG. 6, when the second vehicle 100 has a power feeding port of the type B, a vehicle in front of the second vehicle 100 has a power feeding port of the type A, and the first vehicle 100 has a power feeding unit of the type A, there is no need to change the connector if the second vehicle 100 and the first vehicle 100 are switched. It is therefore possible to improve efficiency of power feeding.

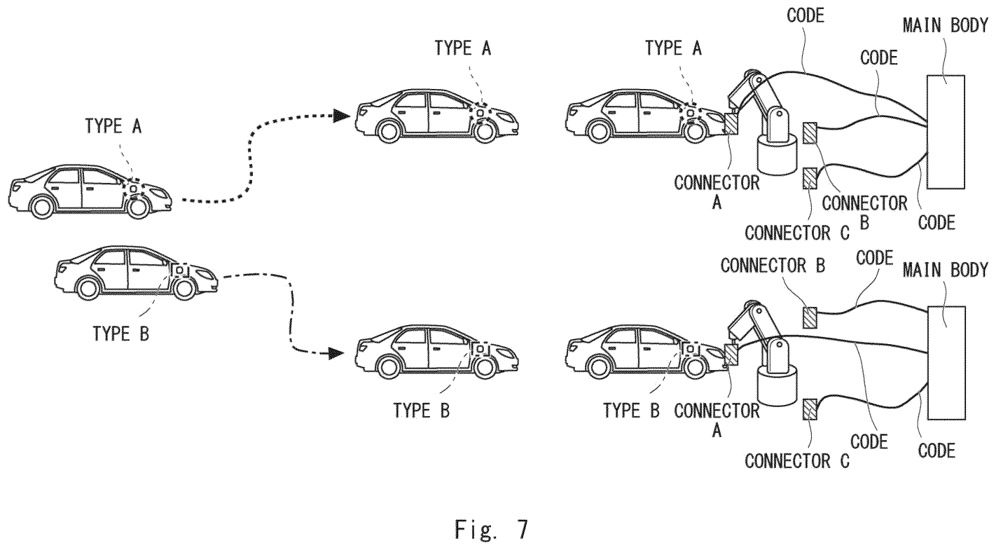

As shown in FIG. 7, for example, vehicles having the power feeding ports of the type A are arranged in the line of vehicles having the power feeding ports of the type A and vehicles having the power feeding ports of the type B are arranged in the line of vehicles having the power feeding ports of the type B, whereby there is no need to change the connector of the power feeding apparatus 700. It is therefore possible to improve efficiency of power feeding. In this manner, the order of the first vehicle 100 and the second vehicle 100 is switched in such a way that vehicles having the same type of power feed connectors are sequential, whereby it is possible to improve efficiency of power feeding.

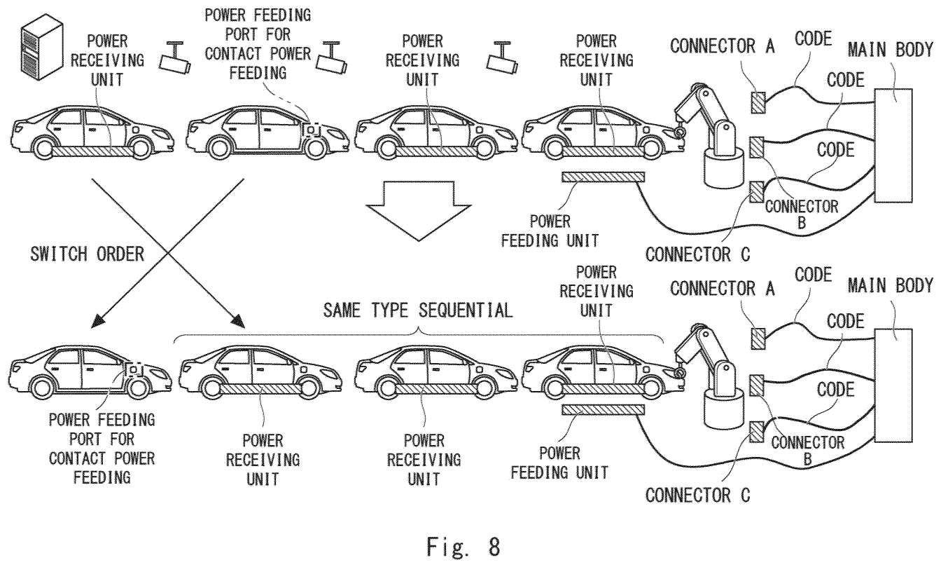

Further, as shown in FIG. 8, for example, when the second vehicle 100 includes a power feeding port for contact power feeding, a vehicle in front of the second vehicle 100 includes a power receiving unit for non-contact power feeding, and the first vehicle 100 includes a power receiving unit for non-contact power feeding, there is no need to change the type of power feeding if the first vehicle 100 and the second vehicle 100 are switched. It is therefore possible to improve efficiency of power feeding.

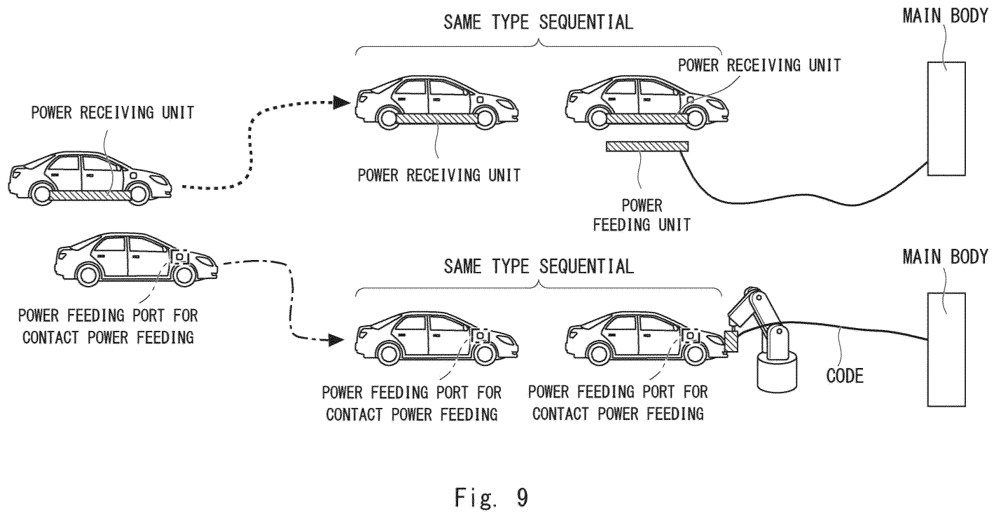

As shown in FIG. 9, for example, vehicles powered by non-contact power feeding are arranged in a line of vehicles powered by non-contact power feeding and vehicles powered by contact power feeding are arranged in a line of vehicles powered by contact power feeding, whereby there is no need to change a connector of the power feeding apparatus 700. It is therefore possible to improve efficiency of power feeding. In this manner, the order of the first vehicle 100 and the second vehicle 100 is switched in such a way that vehicles whose specifications (types) of power feeding are the same are sequential, whereby it is possible to improve efficiency of power feeding.

As described above, the power feeding apparatus specification unit 233 specifies the power feeding apparatus 700 that feeds electric power to the first vehicle 100 in order to improve efficiency of power feeding.

The determination unit 234 determines whether or not to change the order of feeding electric power to the first vehicle 100 and feeding electric power to the second vehicle 100. If the second vehicle 100 is behind the first vehicle 100 by more than a predetermined number of vehicles, the determination unit 234 determines that the order of the first vehicle 100 and the second vehicle 100 may not be switched. Therefore, the order of manufacturing the second vehicle 100 is not delayed too much.

Further, the determination unit 234 determines, when the second vehicle 100 is a predetermined vehicle, that the order of the first vehicle 100 and the second vehicle 100 may not be switched. Therefore, when the second vehicle 100 is a predetermined vehicle, it can be preferentially manufactured.

The second information creation unit 235 creates second information requested for the first vehicle 100, the second vehicle 100 which electric power is fed to by the power feeding apparatus 700 and is closer to the power feeding apparatus 700 than the first vehicle 100 is, or the power feeding apparatus 700. Then the server 200 transmits the second information from the transmitting unit to the first vehicle 100, the second vehicle 100, and the power feeding apparatus 700.

The second information creation unit 235 creates, for example, a control instruction for controlling the first vehicle 100. Specifically, the second information creation unit 235 creates a control instruction for moving the first vehicle 100 to a power feeding place. Further, the second information creation unit 235 may create a control instruction for the first vehicle 100 for switching the order of the first vehicle 100 and the second vehicle 100. The control instruction may be information indicating a speed, an acceleration, a steering angle, or the like of the first vehicle 100. Further, when the first vehicle 100 can autonomously move, the control instruction may be information indicating a route from the current place on a map to a power feeding place on the map or a route for switching the first vehicle 100 and the second vehicle 100. As described above, the second information creation unit 235 creates a control instruction regarding the movement of the first vehicle 100.

The second information creation unit 235 creates, for example, a control instruction for controlling the second vehicle 100. Specifically, the second information creation unit 235 may create a control instruction for the second vehicle 100 for switching the order of the first vehicle 100 and the second vehicle 100. The control instruction may be information indicating a speed, an acceleration, a steering angle, or the like of the second vehicle 100. Further, when the second vehicle 100 can autonomously move, the control instruction may be information indicating a route from the current place on a map to a power feeding place on the map or a route for switching the first vehicle 100 and the second vehicle 100. As described above, the second information creation unit 235 creates a control instruction regarding the movement of the second vehicle 100. Further, the second information creation unit 235 may create information on the second vehicle 100 deviated from the power feeding apparatus 700. The information on the second vehicle 100 deviated from the power feeding apparatus 700 indicates, when the second vehicle 100 is powered by the power feeding apparatus 700, information on an operation for stopping the power feeding and giving its turn to the first vehicle 100.

The second information creation unit 235 creates, for example, second information on the specification of the power feeding of the first vehicle 100. The power feeding apparatus 700 includes an acquisition unit such as a communication apparatus 130 that acquires second information. The power feeding apparatus 700 further includes a determination unit 730, a power feeding control unit 740, and a power feeding unit 720 such as a power feeding coil or a connector. The information on the specification of the power feeding of the first vehicle 100 is transmitted to the power feeding apparatus 700 and is acquired by the acquisition unit of the power feeding apparatus 700. The power feeding control unit 740 of the power feeding apparatus 700 prepares to feed electric power based on the second information.

The preparation for the power feeding means determining, by the determination unit 730, whether or not to remove the connector to be used to feed electric power in accordance with the specification of the power feeding of the first vehicle 100 and maintaining, when the determination unit 730 determines that there is no need to remove the connector, the connector by the power feeding control unit 740. Further, the preparation for the power feeding means connecting, when the determination unit 730 determines that it is necessary to remove the connector, a connector in accordance with the specification of the power feeding of the first vehicle 100 by the power feeding control unit 740.

Further, the preparation for the power feeding means determining, by the determination unit 730, whether or not to change the power feeding voltage of the power feeding unit 720 in accordance with the specification of the power feeding of the first vehicle 100, and maintaining, when the determination unit 730 determines that there is no need to change the power feeding voltage, the voltage by the power feeding control unit 740. Further, the preparation for the power feeding means changing, when the determination unit 730 determines that it is necessary to change the power feeding voltage, the power feeding voltage to one in accordance with the specification of the power feeding of the first vehicle 100 by the power feeding control unit 740.

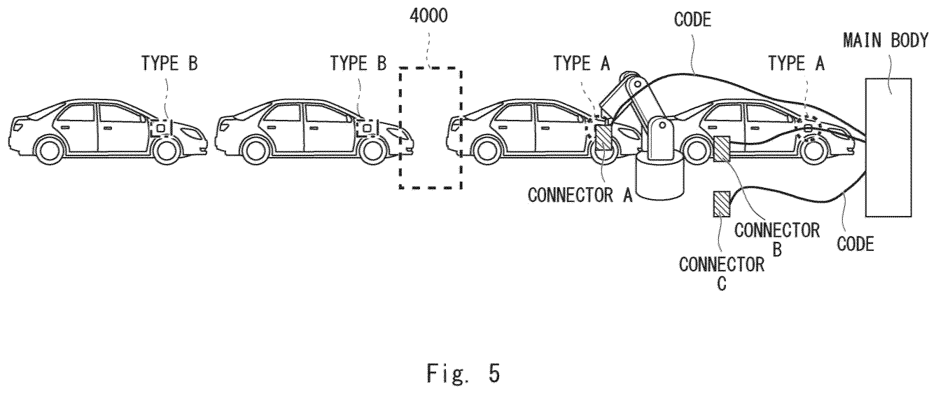

As shown in FIG. 5, a case where vehicles conforming to the first connector are sequential and then vehicles conforming to the second connector are sequential in the power feeding apparatus 700 will be considered. The power feeding control unit 740 may replace the first connector with the second connector after the sequence of the vehicles conforming to the first connector is completed but before vehicles conforming to the second connector come to the power feeding apparatus 700 (4000). In this manner, the power feeding apparatus 700 is able to efficiently perform contact power feeding.

Further, a case where vehicles conforming to the first power feeding voltage are sequential and then vehicles conforming to the second power feeding voltage are sequential in the power feeding apparatus 700 will be considered. The power feeding control unit 740 may change the power feeding voltage from the first power feeding voltage to the second power feeding voltage after completion of the sequence of vehicles conforming to the first power feeding voltage but before the sequence of vehicles conforming to the second power feeding voltage come to the power feeding apparatus. Accordingly, the power feeding apparatus is able to efficiently perform non-contact power feeding.

When the type of the vehicle is changed from a vehicle powered by contact power feeding to a vehicle powered by non-contact power feeding or vice versa, the power feeding control unit 740 may prepare for power feeding before a vehicle powered by a different power feeding method comes. Further, when the first vehicle 100 has a plurality of power feeding methods, a method in which a charging speed is larger or largest may be preferentially used. Accordingly, it is possible to efficiently feed electric power.

The communication apparatus 205 transmits second information such as a control instruction to the vehicle 100. After the communication apparatus 130 of the first vehicle 100 receives the control instruction, the first vehicle 100 moves according to the received control instruction. The vehicle 100 moves including an actuator group 120 and a vehicle control unit 115. The actuator group 120 includes wheel motors for driving wheels, a steering motor for controlling the steering angle, a brake for stopping the vehicle, and the like. The vehicle control unit 115 generates a control signal for controlling the actuator group 120 according to the control instruction. The vehicle control unit 115 may be formed by an Electronic Control Unit (ECU). Accordingly, the vehicle 100 can move to a power feeding place where the power feeding robot 600 and the power feeding apparatus 700 are installed.

Further, when the second vehicle 100 receives the control instruction, the second vehicle 100 moves according to the control instruction. This configuration is the same as that of the first vehicle 100.

The power feeding plan information creation (update) unit 236 changes the power feeding plan so as to improve the efficiency of power feeding, such as feeding electric power to the first vehicle 100 prior to feeding electric power to the second vehicle 100 or feeding electric power to the first vehicle 100 after feeding electric power to the second vehicle 100. According to the power feeding plan, the first vehicle 100 may be arranged in the first power feeding apparatus and the second vehicle 100 may be arranged in the second power feeding apparatus. The power feeding plan is registered in a database that stores production management information or the like, and is used to know whether or not the first vehicle 100 has completed charging.

The server 200 may include a control value creation unit that creates a control value based on type information. For example, the control value is data for specifying a connector depending on the destination. When the information on the destination contained in the type information is for Japan, the control value is data for selecting a connector. Specifically, the control value may be data indicating a connector number or data indicating the position of a connector.

The communication apparatus 205 transmits the control value to the power feeding robot 600. When a communication apparatus 630 of the power feeding robot 600 receives the control value, the power feeding robot 600 performs a power feeding operation. Specifically, the power feeding robot 600 includes an arm control unit 615. The arm control unit 615 controls an arm mechanism 612 so that the arm mechanism 612 holds the connector 711 specified by the control value. Then, the arm control unit 615 controls the arm mechanism 612 so that the connector 711 is connected to the power feeding port 140.

As described above, the control value creation unit creates a control value according to the type information indicating the type of the power feeding port 140. Therefore, the power feeding robot 600 can feed electric power to the vehicle 100 by using (i.e., through) the connector 711 conforming to the power feeding port 140.

Note that communication among the communication apparatus 205, the communication apparatus 330, the communication apparatus 410, and the communication apparatus 130 may be wireless communication or wired communication. Note that at least a part of the function of each block provided in the server 200 may be implemented in the vehicle 100, the external sensor 300, the power feeding robot 600, or the power feeding apparatus 700. The communication apparatus 205, the communication apparatus 330, the communication apparatus 630, and the communication apparatus 130 may have only one of a transmitting function and a receiving function.

### (Power Feeding Operation)

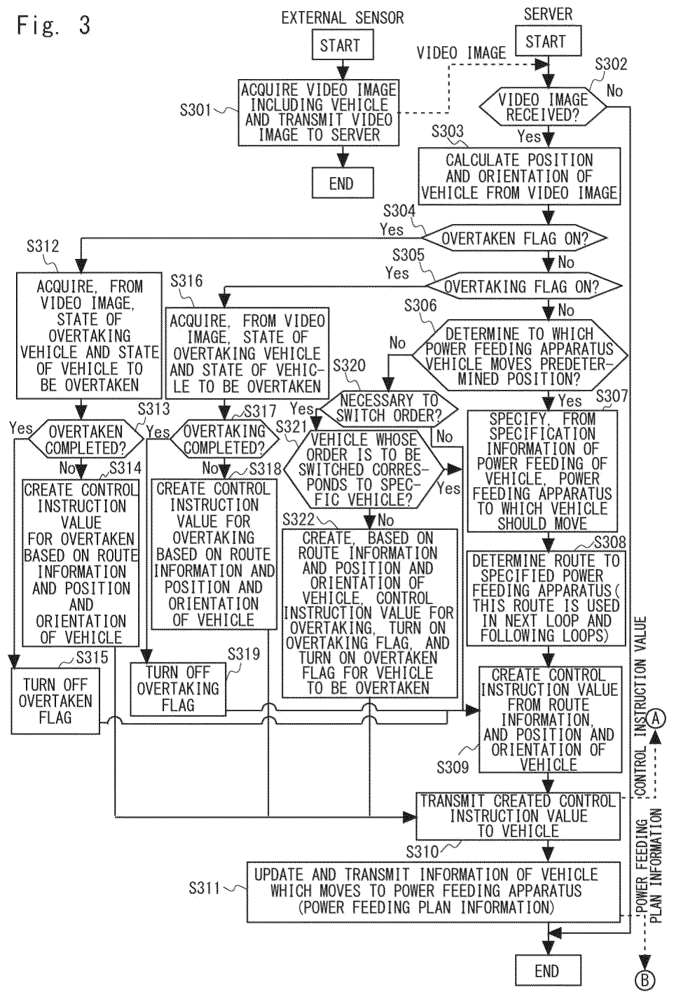

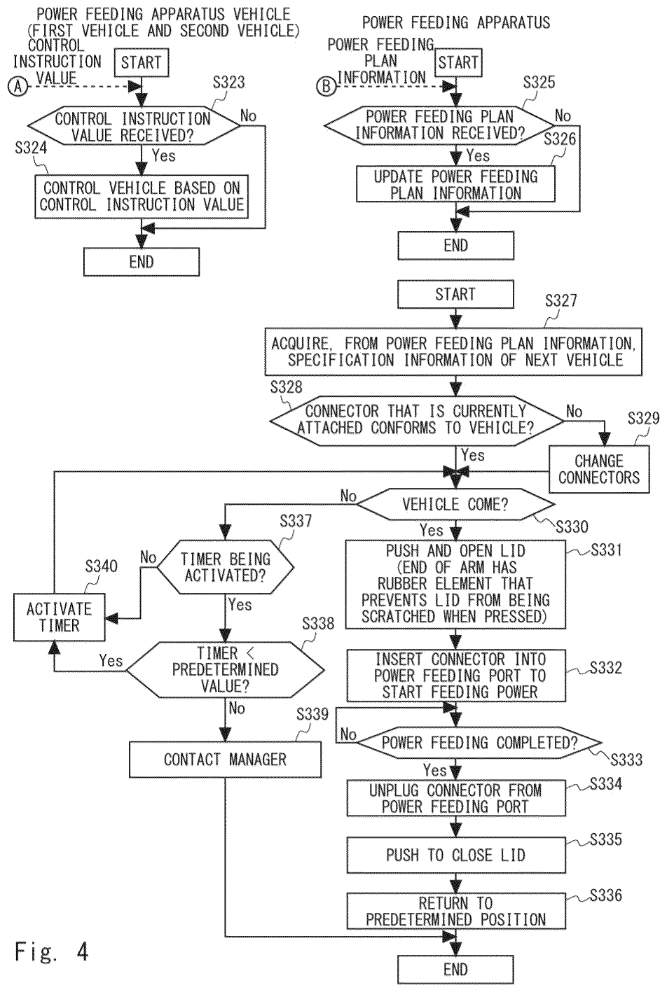

Hereinafter, with reference to FIGS. 3 and 4, an operation of the power feeding system 50 will be described. As shown in FIG. 3, when the external sensor 300 takes an image of a vehicle 100, it transmits the image to the server 200 (Step S301). The server 200 determines whether or not it has received the image (Step S302). When the server 200 has not received the image (No in Step S302), it finishes the process without performing any other process. That is, the server 200 waits until it receives the image from the external sensor 300.

When the server 200 receives the image from the external sensor 300 (Yes in Step S302), the calculation unit 231 calculates the position and the orientation of the vehicle 100 from the image (Step S303). Next, the determination unit 234 determines whether or not an overtaken flag is ON (Step S304). The overtaken flag being ON indicates that it may be manufactured later in view of charging efficiency.

When the determination unit 234 determines that the overtaken flag is not ON (No in Step S304), the determination unit 234 determines whether or not the overtaking flag is ON (Step S305). The overtaking flag being ON indicates that it is manufactured first in view of charging efficiency.

When the determination unit 234 determines that the overtaking flag is not ON (No in Step S305), the power feeding apparatus specification unit 233 determines whether or not the vehicle is in a predetermined position in order to determine to which power feeding apparatus the vehicle should move (Step S306).

When the power feeding apparatus specification unit 233 determines that the vehicle is in the predetermined position (Yes in Step S306), the power feeding apparatus specification unit 233 specifies, from the specification information of power feeding of the vehicle, the power feeding apparatus to which the vehicle should move (Step S307).

Next, the second information creation unit 235 determines a route to the specified power feeding apparatus 700 (Step S308). In the next loop after the flag is created and the subsequent loops, this route is used. Next, the second information creation unit 235 creates a control instruction value of the first vehicle 100 from the route information, and the position and the orientation of the vehicle (Step S309). Next, the created control instruction value is transmitted to the first vehicle 100 (Step S310). Last, the power feeding plan information creation (update) unit updates and transmits information (power feeding plan information) of the vehicle which moves to the power feeding apparatus 700, and the process of the server 200 is finished (Step S311).

When the determination unit 234 determines that the overtaken flag is ON (Yes in Step S304), the server 200 acquires, from the video image taken by the external sensor 300, the state of the overtaking vehicle and that of the vehicle to be overtaken (Step S312). Next, the server 200 determines whether or not the overtaken behavior has been completed (Step S313).

When the server 200 determines that the overtaken behavior has been completed (Yes in Step S313), the overtaken flag is turned off (Step S315). After that, Step S309 is performed. When the server 200 determines that the overtaken behavior has not been completed (No in Step S313), the second information creation unit 235 creates a control instruction value for overtaken based on the route information and the position and the orientation of the vehicle (Step S314). After that, Step S310 is performed.

When the determination unit 234 determines that the overtaking flag is ON (Yes in Step S305), the server 200 acquires the state of the overtaking vehicle and that of the vehicle to be overtaken from the video image taken by the external sensor 300 (Step S316). Next, the server 200 determines whether or not the overtaking behavior has been completed (Step S317).

When the server 200 determines that the overtaking behavior has been completed (Yes in Step S317), the overtaking flag is turned off (Step S319). After that, Step S309 is performed. When the server 200 determines that overtaking has not been completed (No in Step S317), the second information creation unit 235 creates a control instruction value for overtaking based on the route information and the position and the orientation of the vehicle (Step S318). After that, Step S310 is performed.

When the power feeding apparatus specification unit 233 determines that the power feeding apparatus is not in a predetermined position (No in Step S306), the determination unit 234 determines whether or not it is necessary to switch the order of the vehicles (Step S320). When the determination unit 234 determines that there is no need to switch the order of the vehicles (No in Step S320), Step S309 is performed.

When the determination unit 234 determines that it is necessary to switch the order of the vehicles (Yes in Step S320), the determination unit 234 determines whether or not the second vehicle 100 whose order is to be switched corresponds to the specific vehicle (Step S321). The specific vehicle means a vehicle that should be preferentially charged. When it is determined that the second vehicle 100 should be preferentially charged, the order is not switched. When the determination unit 234 determines that the second vehicle 100 corresponds to the specific vehicle (Yes in Step S321), Step S309 is performed.

When the determination unit 234 determines that the second vehicle 100 does not correspond to the specific vehicle (No in Step S321), a control instruction value for overtaking is created and the overtaking flag is turned on based on the route information and the position and the orientation of the vehicle. Further, the overtaken flag for the vehicle to be overtaken is turned on (Step S322). After that, Step S310 is performed.

As shown in FIG. 4, after Step S310, it is determined whether or not the first vehicle 100 and the second vehicle 100, each of which is a power feeding apparatus vehicle, have each received the control instruction value (Step S323). When the power feeding apparatus vehicle has not received the control instruction value (No in Step S323), it finishes the process. That is, the power feeding apparatus vehicle waits until it receives the control instruction value.

When the power feeding apparatus vehicle has received the control instruction value (Yes in Step S323), the vehicle is controlled based on the control instruction value (Step S324). The vehicle control apparatus 110 controls the movement of the vehicle by controlling the actuator group 120.

As shown in FIG. 4, after Step S311, it is determined whether or not the power feeding apparatus 700 has received power feeding plan information (Step

S325). When the power feeding apparatus 700 has not received the power feeding plan information (No in Step S325), it finishes the process. When the power feeding apparatus 700 has received the power feeding plan information (Yes in Step S325), the power feeding plan information is updated (Step S326).

Further, as shown in FIG. 4, the power feeding apparatus 700 acquires, from the power feeding plan information, specification information of the next vehicle (Step S327). Next, the power feeding control unit 740 determines whether or not the connector that is currently attached conforms to the vehicle (Step S328). The power feeding control unit 740 determines whether or not the connector that is currently attached conforms to the vehicle based on the information on the specification of the next vehicle. When the power feeding control unit 740 determines that the connector that is currently attached does not conform to the vehicle (No in Step S328), the connector is changed (Step S329). When the power feeding control unit 740 determines that the connector that is currently attached conforms to the vehicle (Yes in Step S328), and after Step S329 is performed, the power feeding control unit 740 determines whether or not a vehicle has come (Step S330). The power feeding apparatus 700 is ready to accept a vehicle and waits for the vehicle to arrive.

When the power feeding control unit 740 determines that the vehicle has come (Yes in Step S330), a lid of the power feeding port 140 is pushed and opened (Step S331). The end of the arm mechanism 612 has a rubber element that prevents the lid from being scratched when it is pressed. Next, the arm mechanism 612 inserts the connector into the power feeding port 140 to start feeding electric power (Step S332). The power feeding control unit 740 determines whether or not power feeding is completed (Step S333). When power feeding is not completed (No in Step S333), power feeding is continued.

When power feeding is completed (Yes in Step S333), the arm mechanism 612 unplugs the connector from the power feeding port 140 (Step S334). Next, the arm mechanism 612 pushes to close the lid of the power feeding port 140 (Step S335). Next, the connector returns to a predetermined position (Step S336). While contact power feeding using connectors has been described above, in a case in which non-contact power feeding is performed, power feeding can be started at a timing when a vehicle comes to a predetermined position.

When the power feeding control unit 740 determines that no vehicle comes (No in Step S330), the power feeding control unit 740 determines whether or not a timer is being activated (Step S337). When the power feeding control unit 740 determines that the timer is not activated (No in Step S337), the timer is activated (Step S340). After that, Step S330 is performed.

When the power feeding control unit 740 determines that the timer is activated (Yes in Step S337), it is determined whether or not the value of the timer is greater than a predetermined value (Step S338). When the value of the timer is not greater than the predetermined value (Yes in Step S338), Step S340 is performed. When the value of the timer is greater than the predetermined value (No in Step S338), a notification is sent to a manager or the like (Step S339), and it finishes the process. If no vehicle comes, it is assumed that there is a problem, in which case a manager will rush to the site after a certain period of time.

As described above, the power feeding method for efficiently charging vehicles is provided. Such a method is performed by the information processing apparatus, which is the server 200. It can therefore be said that a program for causing the information processing apparatus to perform a power feeding method is also disclosed. As described above, a program for causing the information processing apparatus to efficiently charge vehicles is provided.

### <A. Traveling Control Example 1>

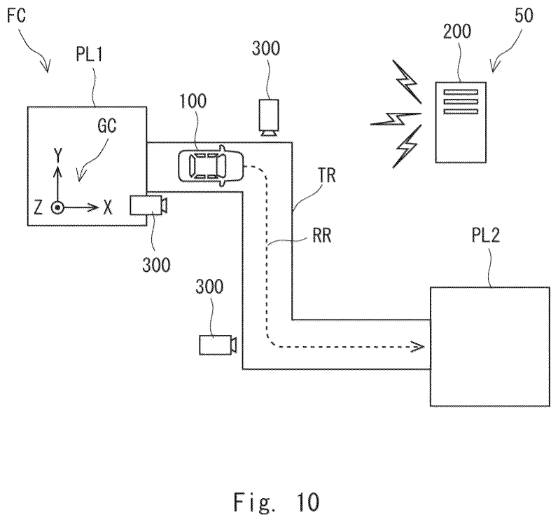

FIG. 10 is a conceptual diagram showing a configuration of a system 50 in Traveling Control Example 1. The system 50 includes at least one vehicle 100 as a mobile object, a server 200, and at least one external sensor 300. The following description will be given on the assumption that the server 200 is the server 200.

Note that when the mobile object is an object other than the vehicle, each of the terms “vehicle” and “car” in the present disclosure can be replaced with a “mobile object” as appropriate, and the term “traveling” can be replaced with a “movement” as appropriate.

The vehicle 100 is configured to be able to travel by an unattended operation. The “unattended operation” means an operation (e.g., driving) that does not rely on a traveling operation performed by an occupant (e.g., a driver). The traveling operation means an operation related to at least one of “running”, “turning”, and “stopping” of the vehicle 100. The unattended operation is carried out by automatic or manual remote control using an apparatus located outside the vehicle 100, or by autonomous control of the vehicle 100. An occupant (e.g., a driver or a passenger) who does not perform a traveling operation may be on board the vehicle 100 which is traveling by an unattended operation. Examples of occupants who do not perform a traveling operation includes a person simply sitting on a seat of the vehicle 100 and a person who performs an operation other than the traveling operation, such as assembling, inspecting, and operating switches while being on board the vehicle 100. Note that the operation (e.g., driving) by a traveling operation performed by an occupant may be referred to as a “manned operation (or piloted operation)”.

In this specification, the “remote control” includes “full remote control” in which all the operations of the vehicle 100 are completely determined from the outside of the vehicle 100, and “partial remote control” in which some of the operations of the vehicle 100 are determined from the outside of the vehicle 100. Further, the “autonomous control” includes “full autonomous control” in which the vehicle 100 autonomously controls its own operations without receiving any information from an apparatus located outside the vehicle 100, and “partial autonomous control” in which the vehicle 100 autonomously controls its own operations by using information received from an apparatus located outside the vehicle 100.

In this embodiment, the system 50 is used in a factory FC in which vehicles 100 are manufactured. The reference coordinate system of the factory FC is a global coordinate system GC. That is, any position in the factory FC is represented by X, Y and Z-coordinates in the global coordinate system GC. The factory FC includes a first place PL1 and a second place PL2. The first and second places PL1 and PL2 are connected to each other by a track TR (e.g., passageway) on which a vehicle 100 can travel. The factory FC includes a plurality of external sensors 300 along the track TR. The positions of the respective external sensors 300 in the factory FC are adjusted in advance. The vehicle 100 moves from the first place PL1 to the second place PL2 through the track TR by an unattended operation.

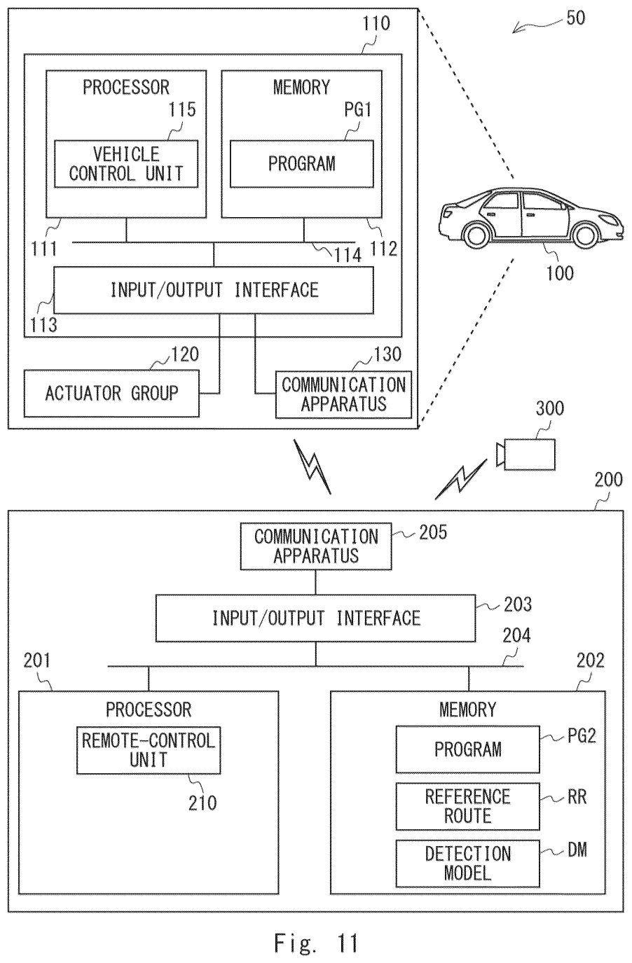

FIG. 11 is a block diagram showing a configuration of the system 50. The vehicle 100 includes a vehicle control apparatus 110 for controlling various units of the vehicle 100, an actuator group 120 including at least one actuator driven under the control of the vehicle control apparatus 110, and a communication apparatus 130 for communicating with an external apparatus such as the server 200 through wireless communication. The actuator group 120 includes an actuator of a driving unit for accelerating the vehicle 100, an actuator of a steering unit for changing the traveling direction of the vehicle 100, and an actuator of a braking unit for decelerating the vehicle 100.

The vehicle control apparatus 110 is composed of a computer including a processor 111, a memory 112, an input/output interface 113, and an internal bus 114. The processor 111, the memory 112, and the input/output interface 113 are connected to each other through the internal bus 114 so that they can bidirectionally communicate with each other. The actuator group 120 and the communication apparatus 130 are connected to the input/output interface 113. The processor 111 implements various functions including the function as the vehicle control unit 115 by executing a program PG1 stored in the memory 112.

The vehicle control unit 115 drives the vehicle 100 by controlling the actuator group 120. The vehicle control unit 115 can drive the vehicle 100 by controlling the actuator group 120 by using a driving control signal received from the server 200. The driving control signal is a control signal for driving the vehicle 100. In this embodiment, the driving control signal includes an acceleration and a steering angle of the vehicle 100 as parameters. In other embodiments, the driving control signal may include a speed of the vehicle 100 as a parameter instead of or in addition to the acceleration of the vehicle 100.

The server 200 is composed of a computer including a processor 201, a memory 202, an input/output interface 203, and an internal bus 204. The processor 201, the memory 202, and the input/output interface 203 are connected through the internal bus 204 so that they can bidirectionally communicate with each other. A communication apparatus 205 for communicating with various apparatuses located outside the server 200 is connected to the input/output interface 203. The communication apparatus 205 can communicate with the vehicle 100 through wireless communication, and can communicate with each of the external sensors 300 through wired communication or wireless communication. The processor 201 implements various functions including the function as the remote-control unit 210 by executing a program PG2 stored in the memory 202.

The remote-control unit 210 acquires a detection result obtained by a sensor, generates a driving control signal for controlling the actuator group 120 of the vehicle 100 by using the detection result, and transmits the generated driving control signal to the vehicle 100. In this way, the remote-control unit 210 drives the vehicle 100 by remote control. The remote-control unit 210 may generate and output, in addition to the driving control signal, control signals for controlling, for example, various auxiliary apparatuses provided in the vehicle 100 and actuators for operating various types of equipment such as wipers, power windows, and lamps. That is, the remote-control unit 210 may operate these various types of equipment and various auxiliary apparatuses by remote control.

The external sensor 300 is a sensor located outside the vehicle 100. The external sensor 300 in this embodiment is a sensor for capturing (e.g., finding and keeping track of) the vehicle 100 from outside the vehicle 100. The external sensor 300 includes a communication apparatus (not shown) and can communicate with other apparatuses such as the server 200 through wired communication or wireless communication.

Specifically, the external sensor 300 is formed by a camera (e.g., a still camera or a video camera). A camera, which functions as the external sensor 300, takes an image (e.g., a still image or a moving image) including (i.e., showing therein) the vehicle 100 and outputs the taken image as a detection result.

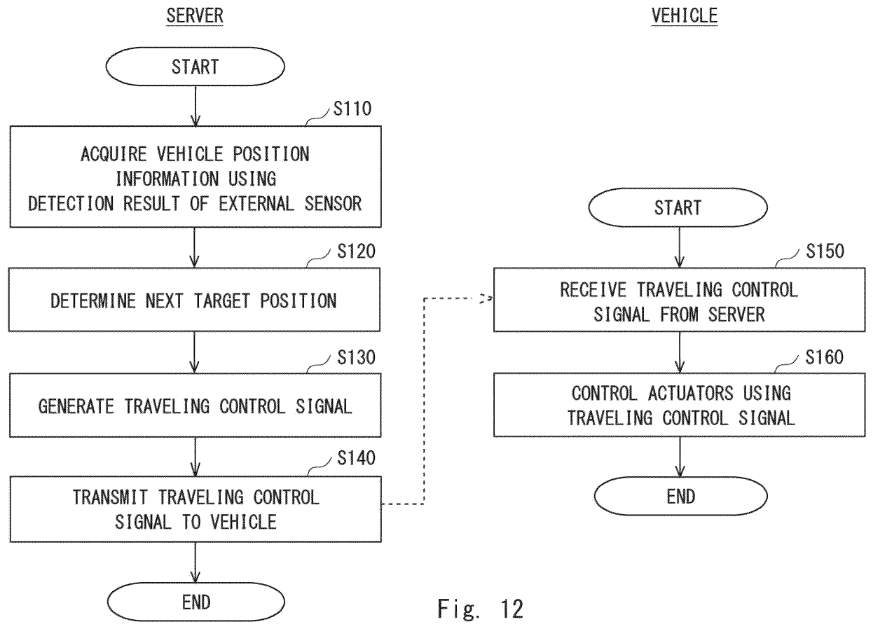

FIG. 12 shows a flowchart showing a procedure of processes for controlling the traveling of a vehicle 100 in a traveling control example. In the procedure of processes shown in FIG. 12, the processor 201 of the server 200 functions as the remote-control unit 210 by executing the program PG2. Further, the processor 111 of the vehicle 100 functions as the vehicle control unit 115 by executing the program PG1.

In a step S110, the processor 201 of the server 200 acquires vehicle position information of the vehicle 100 by using a detection result output from the external sensor 300. The vehicle position information is position information based on which a driving control signal is generated. In this embodiment, the vehicle position information includes the position and orientation of the vehicle 100 in the global coordinate system GC of the factory FC. Specifically, in a step S110, the processor 201 acquires vehicle position information by using the photographed image acquired from the camera serving as the external sensor 300.

Specifically, in the step S110, the processor 201 acquires the position of the vehicle 100 by, for example, detecting the external shape of the vehicle 100 from the photographed image, calculating the coordinates of the positioning point of the vehicle 100 in the coordinate system of the photographed image, i.e., in the local coordinate system, and converting the calculated coordinates into coordinates in the global coordinate system GC. The external shape of the vehicle 100 included (i.e., shown) in the photographed image can be detected by, for example, inputting the photographed image into a detection model DM using artificial intelligence. The detection model DM is prepared, for example, in the system 50 or outside the system 50, and stored in the memory 202 of the server 200 in advance. Examples of the detection model DM include a trained machine-learning model that has been trained to perform either semantic segmentation or instance segmentation. As this machine-learning model, for example, a convolutional neural network (hereinafter also referred to as a CNN) trained through supervised learning using a learning data set can be used. The learning data set includes, for example, a plurality of training images each including the vehicle 100 and labels each indicating whether a respective area in the training image is an area indicating the vehicle 100 or an area that does not indicate a mobile object. When the CNN is trained, it is preferred that parameters of the CNN are updated by backpropagation (error back-propagation method) so that errors between output results by the detection model DM and labels are reduced. Further, the processor 201 can acquire the orientation of the vehicle 100 by, for example, estimating it based on the orientation of the moving vector of the vehicle 100 calculated from changes in the positions of the feature points of the vehicle 100 between frames of the photographed images by using an optical flow method.

In a step S120, the processor 201 of the server 200 determines a target position to which the vehicle 100 should go next. In this embodiment, the target position is represented by X, Y and Z-coordinates in the global coordinate system GC. In the memory 202 of the server 200, a reference route RR, which is a route along which the vehicle 100 should travel, is stored in advance. A route is represented by a node indicating a starting point, a node(s) indicating a passing point(s), a node indicating a destination, and links connecting these nodes with one another. The processor 201 determines a target position to which the vehicle 100 should go next by using the vehicle position information and the reference route RR. The processor 201 determines the target position of the vehicle 100 ahead of the current position thereof on the reference route RR.

In a step S130, the processor 201 of the server 200 generates a driving control signal for driving the vehicle 100 toward the determined target position.

The processor 201 calculates the traveling speed of the vehicle 100 based on the changes in the position of the vehicle 100, and compares the calculated traveling speed with the target speed. When the traveling speed is lower than the target speed, the processor 201 determines, as a whole, the acceleration of the vehicle 100 so that the vehicle 100 accelerates, whereas when the traveling speed is higher than the target speed, the processor 201 determines the acceleration so that the vehicle 100 decelerates. Further, when the vehicle 100 is positioned on the reference route RR, the processor 201 determines the steering angle and the acceleration of the vehicle 100 so that the vehicle 100 does not deviate from the reference route RR, whereas when the vehicle 100 is not positioned on the reference route RR, i.e., the vehicle 100 has deviated from the reference route RR, the processor 201 determines the steering angle and the acceleration so that the vehicle 100 returns to the reference route RR.

In a step S140, the processor 201 of the server 200 transmits the generated driving control signal to the vehicle 100. The processor 201 repeats the acquisition of the position of the vehicle 100, the determination of a target position, the generation of a driving control signal, the transmission of the driving control signal, and the like in a predetermined cycle.

In a step S150, the processor 111 of the vehicle 100 receives the driving control signal transmitted from the server 200. In a step S160, the processor 111 of the vehicle 100 controls the actuator group 120 by using the received driving control signal, and thereby drives the vehicle 100 so as to travel at the acceleration and the steering angle indicated by the driving control signal. The processor 111 repeats the reception of a driving control signal and the control of the actuator group 120 at a predetermined cycle. According to the system 50 in this example, it is possible to drive the vehicle 100 by remote control, and thereby move the vehicle 100 without using conveyance equipment such as a crane or a conveyor.

### <B: Traveling Control Example 2>

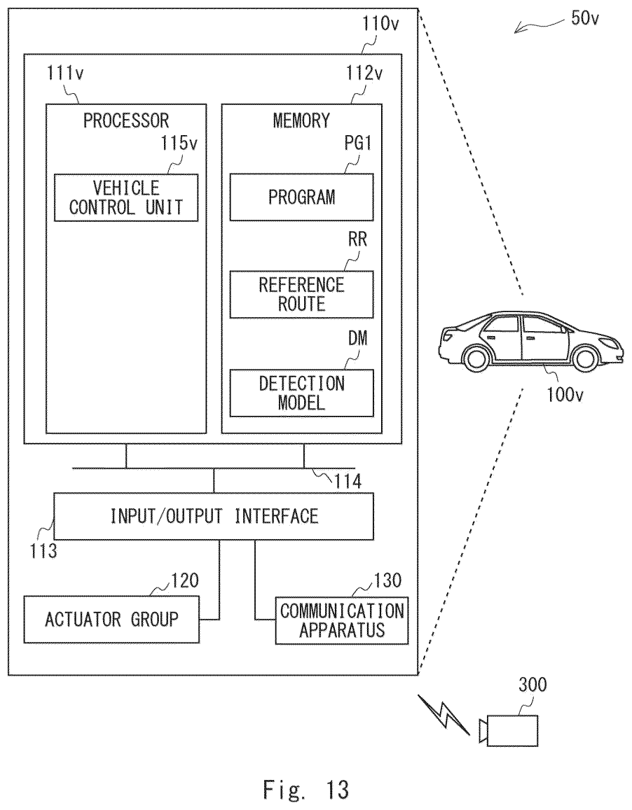

FIG. 13 is an explanatory diagram showing a schematic configuration of a system 50v in Traveling Control Example 2. This example differs from

Traveling Control Example 1 because the system 50v does not includes the server 200. Further, a vehicle 100v in the configuration can travel by autonomous control performed by the vehicle 100v itself. The rest of the configuration is the same as that described above unless otherwise specified.

In this example, a processor 111v of a vehicle control apparatus 110v functions as a vehicle control unit 115v by executing a program PG1 stored in a memory 112v. The vehicle control unit 115v acquires an output result obtained by a sensor, generates a driving control signal by using the output result, and outputs the generated driving control signal and thereby operates the actuator group 120. By doing so, the vehicle control unit 115v can make the vehicle 100v travel by autonomous control performed by the vehicle 100 itself. In this example, in addition to the program PG1, a detection model DM and a reference route RR are stored in the memory 112v in advance.

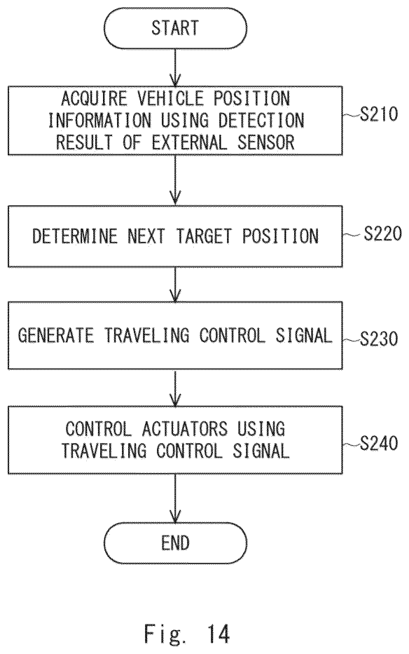

FIG. 14 shows a flowchart showing a procedure of processes for controlling the traveling of the vehicle 100v in Traveling Control Example 2. In the processing procedure shown in FIG. 14, the processor 111v of the vehicle 100v functions as the vehicle control unit 115v by executing the program PG1.

In a step S210, the processor 111v of the vehicle control apparatus 110v acquires vehicle position information by using a detection result output from a camera which is an external sensor 300. In a step S220, the processor 111v determines a target position to which the vehicle 100v should go next. In a step S230, the processor 111v generates a driving control signal for making the vehicle 100v travel toward the determined target position. In a step S240, the processor 111v controls the actuator group 120 by using the generated driving control signal, and thereby makes the vehicle 100v travel according to parameters indicated by the driving control signal. The processor 111v repeats the acquisition of vehicle position information, the determination of a target position, the generation of a driving control signal, and the control of actuators in a predetermined cycle. According to the system 50v in this example, it is possible to make the vehicle 100v travel by autonomous control performed by the vehicle 100v itself without having the server 200 remotely control the vehicle 100v.

### YY: Other Traveling Control Examples

(YY1) In the above-described examples, the external sensor 300 is a camera. However, the external sensor 300 may not be a camera and may be, for example, LiDAR (Light Detection And Ranging). In this case, the detection result output from the external sensor 300 may be 3D (three-dimensional) point cloud data representing the vehicle 100. In this case, the server 200 and the vehicle 100 may acquire vehicle position information by template matching between the 3D point cloud data, which is the detection result, and reference point cloud data prepared in advance.

(YY2) In Traveling Control Example 1, a series of processes from the acquisition of vehicle position information to the generation of a driving control signal are performed by the server 200. However, at least some of the processes from the acquisition of vehicle position information to the generation of a driving control signal may be performed by the vehicle 100. For example, the below-shown Embodiments (1) to (3) may be adopted.

(1) The server 200 may acquire vehicle position information, determine a target position to which the vehicle 100 should go next, and generate a route from the current position of the vehicle 100 indicated by the acquired vehicle position information to the target position. The server 200 may generate a route to a target position which is located between the current position and the destination, or generate a route to the destination. The server 200 may transmit the generated route to the vehicle 100. The vehicle 100 may generate a driving control signal so as to travel along the route received from the server 200, and control the actuator group 120 by using the generated driving control signal.

(2) The server 200 may acquire vehicle position information and transmit the acquired vehicle position information to the vehicle 100. The vehicle 100 may determine a target position to which the vehicle 100 should go next, generate a route from the current position of the vehicle 100 indicated by the received vehicle position information to the target position, generate a driving control signal so as to travel along the generated route, and control the actuator group 120 by using the generated driving control signal.

(3) In the above-described Embodiments (1) and (2), the vehicle 100 may be equipped with an internal sensor, and a detection result output from the internal sensor may be used for at least either the generation of a route or the generation of a driving control signal. The internal sensor is a sensor provided in the vehicle 100. Examples of internal sensors may include a sensor for detecting the motion state of the vehicle 100, a sensor for detecting the operation state of each unit of the vehicle 100, and a sensor for detecting the environment around the vehicle 100. Specifically, examples of internal sensors include a camera, LiDAR, a millimeter-wave radar, an ultrasonic sensor, a GPS sensor, an acceleration sensor, and a gyro sensor. For example, in the above-described Embodiment (1), the server 200 may acquire a detection result obtained by the internal sensor, and when generating a route, take the detection result of the internal sensor into consideration in the generation of the route. In the above-described Embodiment (1), the vehicle 100 may acquire a detection result obtained by the internal sensor, and when generating a driving control signal, take the detection result of the internal sensor into consideration in the generation of the driving control signal. In the above-described Embodiment (2), the vehicle 100 may acquire a detection result obtained by the internal sensor, and when generating a route, take the detection result of the internal sensor into consideration in the generation of the route. In the above-described Embodiment (2), the vehicle 100 may acquire a detection result obtained by the internal sensor, and when generating a driving control signal, take the detection result of the internal sensor into consideration in the generation of the driving control signal.

(YY3) In Traveling Control Example 2, the vehicle 100v may be equipped with an internal sensor, and a detection result output from the internal sensor may be used for at least either the generation of a route or the generation of a driving control signal. For example, the vehicle 100v may acquire a detection result obtained by the internal sensor, and when generating a route, take the detection result of the internal sensor into consideration in the generation of the route. The vehicle 100v may acquire a detection result obtained by the internal sensor, and when generating a driving control signal, take the detection result of the internal sensor into consideration in the generation of the driving control signal.

(YY4) In Traveling Control Example 2, the vehicle 100v acquires vehicle position information by using a detection result obtained by an external sensor 300. However, the vehicle 100v may be equipped with an internal sensor, and the vehicle 100v may acquire vehicle position information by using the detection result of the internal sensor, determine a target position to which the vehicle 100v should go next, generate a route from the current position of the vehicle 100v indicated by the acquired vehicle position information to the target position, generate a driving control signal for traveling along the generated route, and control the actuator group 120 by using the generated driving control signal. In this case, the vehicle 100v can travel without using the detection result of the external sensor 300 at all. Note that the vehicle 100v may acquire a target arrival time and traffic congestion information from outside the vehicle 100v and take the target arrival time and traffic congestion information into consideration in at least either the generation of a route or the generation of a driving control signal. Further, all the functions of the system 50v may be provided in the vehicle 100v. That is, the whole processing implemented by the system 50v according to the present disclosure may be implemented by the vehicle 100v alone.

(YY5) In Traveling Control Example 1, the server 200 automatically generates a driving control signal to be transmitted to the vehicle 100. However, the server 200 may generate a driving control signal to be transmitted to the vehicle 100 according to an operation performed by an operator who is present outside the vehicle 100. For example, an operator present outside the vehicle 100 may operate a controlling apparatus including a display for displaying a photographed image output from an external sensor 300, a steering wheel, an accelerator pedal, and a brake pedal for remotely controlling the vehicle 100, and a communication apparatus for communicating with the server 200 through wired communication or wireless communication. Then, the server 200 may generate a driving control signal according to operations performed on the controlling apparatus.

(YY6) In each of the above-described traveling control examples, it is sufficient if the vehicle 100 has a configuration capable of moving the vehicle 100 by an unattended operation. For example, the vehicle 100 may be in the form of a platform including the below-described configuration. Specifically, it is sufficient if the vehicle 100 include at least a vehicle control apparatus 110 and an actuator group 120 in order to perform three functions of “running”, “turning”, and “stopping” by an unattended operation. In the case where the vehicle 100 acquires information from the outside the vehicle 100 in order to perform an unattended operation, it is sufficient if the vehicle 100 further include a communication apparatus 130. That is, the vehicle 100 capable of moving by an unattended operation may not include at least some of interior components such as a driver's seat and a dashboard, may not include at least some of exterior components such as a bumper and a fender, and may not include a body shell. In this case, the remaining components such as a body shell may be attached to the vehicle 100 until the vehicle 100 is shipped from the factory FC. Alternatively, the vehicle 100 may be shipped from the factory FC without the remaining components such as a body shell, and then these remaining components such as a body shell may be attached to the vehicle 100 after the shipment. These components may be attached from arbitrary directions such as from above, from below, from front, from rear, from the right side, or from the left side of the vehicle 100. Further, they may be attached from the same direction or from different directions. Note that in the case of being formed as a platform, its position may be determined in the same manner as the position of the vehicle 100 is determined in the first embodiment.

(YY7) The vehicle 100 may be manufactured by combining a plurality of modules with each other. The module means a unit composed of a plurality of components that are assembled according to the place in the vehicle 100 at which the module is used and/or according to the function in the vehicle 100. For example, the platform of the vehicle 100 may be manufactured by combining a front module constituting the front part of the platform, a center module constituting the central part of the platform, and a rear module constituting the rear part of the platform with each other. Note that the number of modules constituting the platform is not limited to three, but may be two or less, or four or more. Further, in addition to or instead of the components constituting the platform, components constituting a part of the vehicle 100 other than the platform may be assembled into a module. Further, they may include various modules including optional exterior components such as a bumper and a grill, and optional interior components such as a seat and a console. Further, what is manufactured is not limited to the vehicle 100. That is, any type of mobile object may be manufactured by combining a plurality of modules with each other. Such modules may be manufactured, for example, by joining a plurality of components by welding or by using fixtures, or may be manufactured by integrally molding at least some of the components constituting the module into one component by casting. A molding method for integrally molding one component, particularly a relatively large component, may also be called giga-casting or mega-casting. For example, the aforementioned front module, the center module, and the rear module may be manufactured by giga-casting.

(YY8) The conveyance of a vehicle 100 that is carried out by making the vehicle 100 travel by an unattended operation is also called “self-propelled conveyance”. Further, the configuration for carrying out self-propelled conveyance is also called a “vehicle remote control autonomous traveling conveyance system”. Further, the production method for producing vehicles 100 by using self-propelled conveyance is also called “self-propelled production”. In the self-propelled production, for example, at least some of the conveyance of vehicles 100 is carried out by self-propelled conveyance in the factory FC in which vehicles 100 are manufactured.

(YY9) In each of the above-described traveling control examples, some or all of the functions and processes implemented by software may be implemented by hardware. Further, some or all of the functions and processes implemented by hardware may be implemented by software. As the hardware for implementing various functions in each of the above-described embodiments, various circuits such as integrated circuits and/or discrete circuits may be used.

Further, some or all of the processes performed in the above-described external sensor 300, the vehicle 100, the server 200, the external sensor 300, the power feeding robot 600, and the like can be implemented in the form of a computer program. Such a program can be stored and provided to the computer by using any type of non-transitory computer readable media. Non-temporary computer readable media include various types of substantial recording media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, a CD-R/W, and a semiconductor memory (such as a mask ROM, a PROM (Programmable ROM), an EPROM (Erasable PROM), a flash ROM, and a RAM (Random Access Memory)). Further, the program may be supplied to the computer by various types of temporary computer readable media. Examples of transitory computer readable media include electric signals, optical signals, and electromagnetic waves. Temporary computer readable media can provide programs to computers through wired or wireless communication channels such as wires and optical fibers.

Note that the present invention is not limited to the above-described example embodiments, and they can be modified as appropriate without departing from the scope and spirit of the invention. For example, the change in the order of vehicles for power feeding can be replaced by a change in the order of loading a ship with vehicles. In this case, after vehicles of the same type are aligned, the ship may be loaded with these vehicles by vehicle platooning. Further, the order of vehicles may be changed in such a way that vehicles of the same type are aligned when the ship is loaded with the vehicles. Further, the order of vehicles may be changed in order to align vehicles of the same type when they are inspected.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An information processing apparatus comprising:
an acquisition unit configured to acquire first information on a specification of power feeding of a first vehicle;
a power feeding apparatus specification unit configured to specify a power feeding apparatus that feeds electric power to the first vehicle based on the acquired information on the specification; and
an information creation unit configured to create second information requested for the first vehicle, a second vehicle which power is fed to by the power feeding apparatus and is closer to the power feeding apparatus than the first vehicle is, or the power feeding apparatus.

2. The information processing apparatus according to claim 1, wherein
the information processing apparatus comprises a transmitting unit configured to transmit the second information to the first vehicle,
the first vehicle is controlled based on the second information, and
the second information is at least one of:
a route along which the first vehicle moves to the specified power feeding apparatus; or
a control instruction value of the first vehicle for causing the first vehicle to move to the power feeding apparatus; or
a route of the first vehicle for switching an order of the first vehicle and the second vehicle; or
a control instruction value of the first vehicle for switching the order of the first vehicle and the second vehicle.

3. The information processing apparatus according to claim 1, wherein
the information processing apparatus is mounted on the first vehicle,
the first vehicle is controlled based on the second information,
the second information is at least one of:
a route along which the first vehicle moves to the specified power feeding apparatus; or
a control instruction value of the first vehicle for causing the first vehicle to move to the power feeding apparatus; or
a route of the first vehicle for switching an order of the first vehicle and the second vehicle; or
a control instruction value of the first vehicle for switching the order of the first vehicle and the second vehicle.

4. The information processing apparatus according to claim 1, wherein
the information processing apparatus comprises a transmitting unit configured to transmit the second information to the second vehicle,
the second vehicle is controlled based on the second information,
the second information is at least one of:
a route of the second vehicle for switching an order of the first vehicle and the second vehicle; or
a control instruction value of the second vehicle for switching the order of the first vehicle and the second vehicle; or
information on the second vehicle deviating from the power feeding apparatus.

5. The information processing apparatus according to claim 4, wherein the information processing apparatus is mounted on the first vehicle.

6. The information processing apparatus according to claim 2, wherein the order of the first vehicle and the second vehicle is not switched when the second vehicle is behind the first vehicle by more than a predetermined number of vehicles.

7. The information processing apparatus according to claim 2, wherein the order of the first vehicle and the second vehicle is not switched when the second vehicle is a predetermined vehicle.

8. The information processing apparatus according to claim 2, wherein the order of the first vehicle and the second vehicle is switched in such a way that vehicles having the same power feed connector are sequential.

9. The information processing apparatus according to claim 1, wherein the power feeding apparatus specification unit specifies the power feeding apparatus in such a way that vehicles whose specifications of power feeding are the same are sequential.

10. The information processing apparatus according to claim 1, wherein the information processing apparatus acquires the first information by referring to production management information.

11. The information processing apparatus according to claim 1, wherein, when the first vehicle has a plurality of power feeding methods, a method in which a charging speed is larger or largest is preferentially used.

12. The information processing apparatus according to claim 1, wherein
the second information is information on a specification of power feeding of the first vehicle, and
the information processing apparatus comprises a transmitting unit configured to transmit the second information to the power feeding apparatus.

13. A power feeding apparatus comprising:
an acquisition unit configured to acquire information on a specification of power feeding of a vehicle; and
a power feeding control unit configured to prepare for feeding power based on the acquired information on the specification of power feeding.

14. The power feeding apparatus according to claim 13, wherein
the preparation for the power feeding comprises:
determining whether or not to remove the connector to be used to feed electric power in accordance with a specification of power feeding of the vehicle;
maintaining the connector when it is determined that there is no need to remove the connector, and
connecting a connector in accordance with the specification of power feeding of the vehicle when it is determined that it is necessary to remove the connector.

15. The power feeding apparatus according to claim 14, comprising replacing, when vehicles conforming to the first connector are sequential and then vehicles conforming to the second connector are sequential in the power feeding apparatus, the first connector with the second connector after the sequence of the vehicles conforming to the first connector is completed but before the vehicles conforming to the second connector come to the power feeding apparatus.

16. The power feeding apparatus according to claim 13, wherein
the preparation for the power feeding comprises:
determining, in accordance with a specification of power feeding of the vehicle, whether or not to change a power feeding voltage of a power feeding unit;
maintaining the voltage when it is determined that there is no need to change the power feeding voltage; and
changing, when it is determined that it is necessary to change the power feeding voltage, the power feeding voltage to one in accordance with the specification of the power feeding of the vehicle.

17. The power feeding apparatus according to claim 16, wherein, when vehicles conforming to the first power feeding voltage are sequential and then vehicles conforming to the second power feeding voltage are sequential in the power feeding apparatus, the first power feeding voltage is changed to the second power feeding voltage after the sequence of the vehicles conforming to the first power feeding voltage is completed but before the vehicles conforming to the second power feeding voltage come to the power feeding apparatus.

18. A power feeding method comprising:
acquiring first information on a specification of power feeding of a first vehicle;
specifying a power feeding apparatus that feeds electric power to the first vehicle based on the acquired information on the specification; and
creating second information requested for the first vehicle, a second vehicle which power is fed to by the power feeding apparatus and is closer to the power feeding apparatus than the first vehicle is, or the power feeding apparatus.

19. A non-transitory computer readable medium storing a program for causing an information processing apparatus to execute the power feeding method according to claim 18.
